(19) United States
(12) Patent Application Publication
(10) Pub. No.: US 2016/0347177 A1
(43) Pub. Date: Dec. 1, 2016

(54) OPERATING DEVICE

(71) Applicant: Yazaki Corporation, Tokyo (JP)

(72) Inventors: Yoshimichi MOCHIZUKI, Shizuoka (JP); Yoshiharu MATSUO, Shizuoka (JP); Yoshiyuki MIZUNO, Shizuoka (JP)

(73) Assignee: Yazaki Corporation, Tokyo (JP)

(21) Appl. No.: 15/235,318

(22) Filed: Aug. 12, 2016

Related U.S. Application Data
(63) Continuation of application No. PCT/JP2014/083887, filed on Dec. 22, 2014.

(30) Foreign Application Priority Data
Mar. 17, 2014 (JP) 2014-053197

(51) Int. Cl. B60K 35/00; G06F 3/0481; G06F 3/0362; G06F 3/0484; G06F 3/0338; B62D 1/04; G06F 3/0482

(52) U.S. Cl. CPC B60K 35/00; B62D 1/046; G06F 3/04817; G06F 3/0482; G06F 3/04847; G06F 3/0338; G06F 3/0362; B60K 2350/1064; B60K 2350/928; B60K 2350/1008

(57) ABSTRACT

An operating device includes an operating unit (10) that is one for an operator to select a plurality of operation modes of an on-vehicle device as an operation target; an operating direction detector that detects an operating direction of the operating unit; a display unit that displays an image corresponding to an operation of the operating unit; and a controller that controls the on-vehicle device depending on operation content of the operating unit and alters display content of the display unit depending on the operation content. The controller causes the display unit to display as selection icons a plurality of operation modes out of the respective operation modes in the selection mode corresponding to an operating direction of the operating unit and to make the selection icon of the selection mode selected according to the operation of the operating unit visually prominent.

### CROSS-REFERENCE TO RELATED APPLICATION

This application is a continuation application of International Application PCT/JP2014/083887, filed on Dec. 22, 2014, and designating the U.S., the entire contents of which are incorporated herein by reference.

### BACKGROUND OF THE INVENTION

1. Field of the Invention

The present invention relates to an operating device.

2. Description of the Related Art

Conventionally, in vehicle interior, provided has been an operating device for operating a plurality of on-vehicle devices such as lighting instruments and windshield wipers that are installed in a vehicle. As for the operating device, a lever switch in which an operating lever and the like extend from a steering column on the rear side (on an instrument side) of a steering wheel is known, for example. Such a lever switch allows, by the arrangement thereof, a driver to operate it without taking his/her hands off the steering wheel, and thus is one that is easy to operate while driving. However, this lever switch is arranged without being associated with the position of the on-vehicle device installed in the vehicle in some cases. Because of this, it is hard for the driver to intuitively comprehend which of a plurality of on-vehicle devices the operation of the lever switch operates and what kind of functions of the on-vehicle devices the operation of the lever switch operates.

The following Japanese Patent No. 4337003 discloses an operating device that is configured to resolve such difficulty in intuitive comprehension while preventing an erroneous operation of the driver. This operating device is the one that an annular switch on which rotating operation (an operation along a circumferential direction of the shaft of a lever switch) and sliding operation (an operation along the shaft of the lever switch) are performed is provided on the lever switch, and that a plurality of functions of the on-vehicle devices are displayed on a display unit with icons by grouping for each on-vehicle device. In the operating device, a plurality of functions for each on-vehicle device can be selected depending on the rotating operation of the annular switch, and the group of functions for each on-vehicle device can be selected depending on the sliding operation of the annular switch. Furthermore, in the operating device, the background of each icon of the group selected by the sliding operation is displayed visually prominently by highlighting, and the icon of the function selected by the rotating operation is displayed visually prominently by highlighting.

In the foregoing conventional operating device, however, because the on-vehicle device to be an operation target is switched by the sliding operation, the driver may feel that switching operation cumbersome.

### SUMMARY OF THE INVENTION

Consequently, an object of the present invention is to provide an operating device for which the usability of the driver has been improved.

In order to achieve the above mentioned object, an operating device according to one aspect of the present invention includes an operating unit configured to select by an operator a plurality of operation modes of an on-vehicle device as an operation target, operable in an operating direction assigned for each of a plurality of selection modes, and capable of selecting the respective operation modes of the selection mode assigned to the operating direction according to an operation to the operating direction; an operating direction detector that detects an operating direction of the operating unit; a display unit that displays an image corresponding to an operation of the operating unit; and a controller configured to control the on-vehicle device depending on operation content of the operating unit and alter display content of the display unit depending on the operation content, wherein the controller causes the display unit to display as selection icons a plurality of operation modes out of the respective operation modes in the selection mode corresponding to an operating direction of the operating unit and to make the selection icon of the selection mode selected according to the operation of the operating unit visually prominent.

According to another aspect of the present invention, in the operating device, it is desirable that the controller displays a plurality of selection icons for each selection mode displayed on the display unit in association with operating directions of the operating unit corresponding to the selection mode so as to enable the operator to recognize the operating directions of the operating unit corresponding to the selection mode from the display content of the display unit.

According to still another aspect of the present invention, in the operating device, it is desirable that the controller causes the display unit to display for each selection mode an operating direction icon indicative of an operating direction of the operating unit side by side with a plurality of selection icons in the selection mode.

According to still another aspect of the present invention, in the operating device, it is desirable that the controller causes the display unit to display an operating unit icon that represents appearance of the operating unit.

According to still another aspect of the present invention, in the operating device, it is desirable that the controller moves the respective selection icons in the selection mode corresponding to the operating direction on the display unit each time the operating unit is operated, and out of the respective selection modes displayed on the display unit, makes the selection icon moved to a certain highlight position visually prominent.

According to still another aspect of the present invention, in the operating device, it is desirable that the controller, when the operating unit is operated, causes the display unit to display at least the selection icon selected according to the operation of the operating unit and the selection icon that is to be selected when the operating unit is further operated to the operating direction the same as or opposite to the operation.

According to still another aspect of the present invention, in the operating device, it is desirable to further includes an operational intention detector that detects an operational intention of the operating unit by the operator, wherein the controller desirably causes the display unit to display the selection icons when an operational intention of the operator for the operating unit has been detected by the operational intention detector.

According to still another aspect of the present invention, in the operating device, it is desirable that a plurality of operating units are provided and the operational intention detector is provided for each of the operating units, and the controller causes the display unit to display the selection icons for each selection mode concerning the operating unit for which the operational intention of the operator has been detected by the operational intention detector.

According to still another aspect of the present invention, in the operating device, it is desirable that the respective operating units are arranged on a right-hand side of a vehicle and/or a left-hand side of the vehicle with respect to a steering column in vehicle interior, the controller associates circumferential edge portions of the display unit on the right-hand side of the vehicle and the left-hand side of the vehicle with the right-hand side of the vehicle and the left-hand side of the vehicle with respect to the steering column, respectively, and displays operating-unit position icons indicative of arrangement of the respective operating units with respect to the steering column on the circumferential edge portions of the display unit on the right-hand side of the vehicle and the left-hand side of the vehicle, and the controller grasps the operating unit for which an operational intention of the operator is detected by the operational intention detector, and makes the selection icons for each selection mode concerning the grasped operating unit appear from a position of the circumferential edge portion of the display unit associated with the operating unit.

According to still another aspect of the present invention, in the operating device, it is desirable that the operating unit includes a lever switch that includes an operating lever projecting from a steering column in vehicle interior, and the operating lever is configured to be operable in a plurality of directions with respect to a neutral position.

According to still another aspect of the present invention, in the operating device, it is desirable that the operating unit includes a rotary switch that is a switch provided at an end portion on an opposite side of a fulcrum point of the operating lever and is operable in a circumferential direction with respect to a central axis of the operating lever.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front view illustrating a configuration of an operating device according to a first embodiment of the present invention;

FIG. 2 is a top view illustrating a configuration of the operating device in the first embodiment of the present invention;

FIG. 3 is a front view of a combination meter that a display unit depicted in FIG. 1 is incorporated with;

FIG. 4 is a diagram illustrating one example of an operation guidance screen in the first embodiment;

FIG. 5 is a flowchart for explaining arithmetic process operation of a controller;

FIG. 6 is a diagram illustrating another example of the operation guidance screen in the first embodiment;

FIG. 7 is a front view illustrating a configuration of an operating device according to a second embodiment of the present invention;

FIG. 8 is a diagram illustrating one example of a normal screen and operating-unit position icons in the second embodiment; and

FIG. 9 is a diagram illustrating one example of an operation guidance screen and the operating-unit position icons in the second embodiment.

### DETAILED DESCRIPTION OF THE PREFERRED EMBODIMENTS

The following describes embodiments of an operating device according to the present invention in detail based on the accompanying drawings. The invention, however, is not intended to be limited by these embodiments.

### First Embodiment

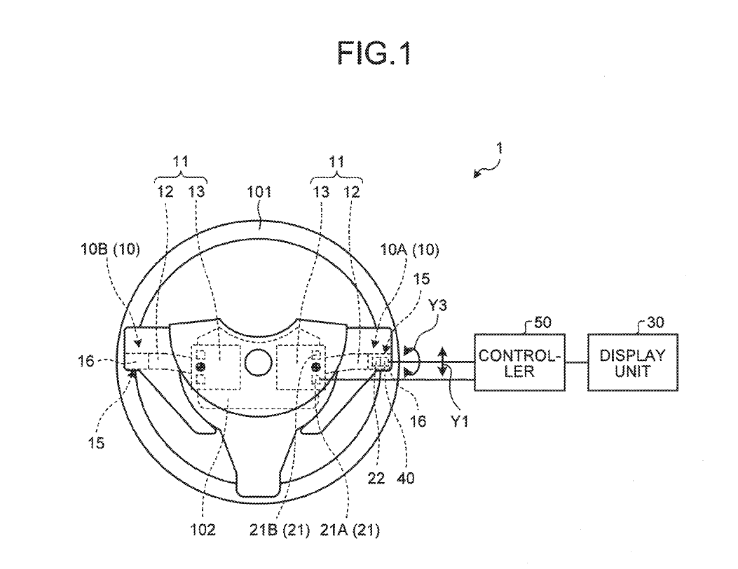

A first embodiment of an operating device according to the present invention will be described based on FIGS. 1 to 6.

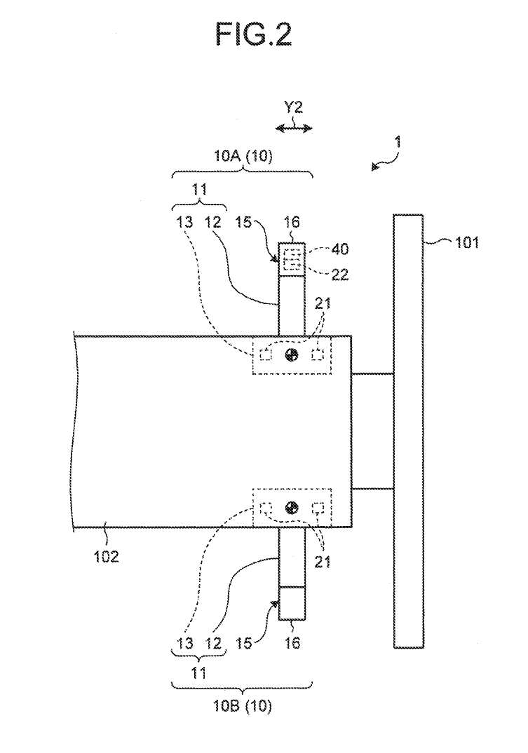

The reference sign 1 in FIGS. 1 and 2 represents an operating device in the first embodiment. This operating device 1 is the one that is used by an operator (in particular, a driver) to operate or stop on-vehicle devices (not depicted) installed in a vehicle, and is arranged in the vehicle interior. For example, the operating device 1 is arranged around the driver seat such that the driver can use it while driving. Specifically, in the first embodiment, the operating device 1 that is arranged on a steering column 102 on the rear side (on an instrument side) of a steering wheel 101 in the vehicle interior will be described as an example.

The on-vehicle device is an operation target of the operating device 1, and has at least one operation mode that is operated along with the operation of the operating device 1 by the operator. For example, as the on-vehicle devices, lighting devices (headlights and tail lights), turn signals, windshield wipers, and others of the vehicle are included. As for the ones installed in the vehicle interior, acoustic equipment such as audio equipment and a radio, an air conditioning unit (what is called an air conditioner), and others correspond to the on-vehicle devices. Furthermore, as the on-vehicle devices, although not installed in the vehicle itself, the devices (for example, a mobile phone, a portable music player, and others) that are installed in the vehicle by being brought in by an occupant such as the driver are also included.

The operating device 1 in the first embodiment is configured as the one that is capable of operating a plurality of types of on-vehicle devices. Thus, the operating device 1 can let the operator select one or a plurality of operation modes of the on-vehicle devices. In the following description, however, a point of letting the operator select a plurality of operation modes that the on-vehicle devices have will be explained.

This operating device 1 includes at least one operating unit 10 that is operable in an operating direction assigned for one of a plurality of selection modes, and according to the operation to that operating direction, is capable of selecting the respective operation modes of the selection mode assigned to that operating direction.

The selection mode means the one that, when a single on-vehicle device that is operable in a plurality of operation modes is assumed and the operation modes of the on-vehicle device are separable for each of certain function groups, corresponds to the respective function groups. For example, when the on-vehicle device is a windshield wiper, there are operation modes of a plurality of operating speeds in normal operation and that of normal operation stop, and there are operation modes of a plurality of operating intervals in intermittent operation that are different from the normal operation, and that of intermittent operation stop. Consequently, in this windshield wiper, function groups can be separated into normal operation modes and intermittent operation modes, and thus the normal operation modes and the intermittent operation modes are to be present as the selection modes. That is, the selection mode, when applied to a single on-vehicle device, means a mode in which a plurality of operation modes are put together into one by a certain relevant function.

The selection mode in this illustration will be described as the one that is sorted by such function groups. The selection mode, however, may be defined by assigning to each on-vehicle device as a mode to select the on-vehicle device itself to be an operation target. For example, when the on-vehicle devices to be the operation target of the operating device 1 are lighting devices and windshield wipers, selection modes to operate and stop the lighting devices are arranged and selection modes to operate and stop the windshield wipers are arranged.

With respect to the steering column 102, at least one operating unit 10 is arranged on the right-hand side of the vehicle and/or on the left-hand side of the vehicle. The operating device 1 in the first embodiment is provided with, as the operating units 10 thereof, two operating units 10A and 10B. In this illustration, with respect to the steering column 102, the operating unit 10A is arranged on the right-hand side of the vehicle and the operating unit 10B is arranged on the left-hand side of the vehicle. The operating unit 10 of the first embodiment is configured with a combination of a main operating unit 11 and a sub-operating unit 15. The main operating unit 11 is the one that is operable in a plurality of directions with respect to a neutral position. The sub-operating unit 15 is the one that is operable in directions different from the operating directions of the main operating unit 11. While the operating unit 10A on the right-hand side of vehicle is presented as an example in FIGS. 1 and 2, as with the operating unit 10A, the operating unit 10B on the left-hand side of the vehicle also is configured with a combination of the main operating unit 11 and the sub-operating unit 15.

The main operating unit 11 in this illustration is a lever switch having an operating lever 12 projecting from the steering column 102 and is the one that is configured such that the operating lever 12 is operable in a plurality of directions with respect to the neutral position. The operating lever 12 includes a main body portion that is a cylindrical member extending in an axis direction, for example. The main body portion may be the one that is formed on a straight line or may be the one that is provided with a curved portion halfway through the path. The operating lever 12 of the operating unit 10A projects toward the right of the vehicle and upward from the side surface of the steering column 102 on the right-hand side of the vehicle. Meanwhile, the operating lever 12 of the operating unit 10B projects toward the left of the vehicle and upward from the side surface of the steering column 102 on the left-hand side of the vehicle.

The main operating unit 11 includes a support mechanism 13 that supports an end portion of the operating lever 12 on the steering column 102 side. The support mechanism 13 supports the operating lever 12 in the inside of the steering column 102 so that the operating lever 12 can be freely tilted toward certain operating directions centering on the neutral position with the end portion as a fulcrum point.

In the operating lever 12, the direction of tilt is the operating direction of the main operating unit 11. In the operating lever 12 in this illustration, the circumferential direction centering on the central axis of rotation of the steering wheel 101 and the axial direction of the central axis of the rotation thereof are defined as the operating directions. The operating lever 12 tilts, centering on the neutral position, toward one direction and the other direction out of that circumferential direction. In the following description, those operating directions to the respective circumferential directions are referred to as “first operating direction Y1” (FIG. 1). The operating lever 12 further tilts, centering on the neutral position, toward one direction and the other direction out of that axial direction. In the following description, those operating directions to the respective axial directions are referred to as “second operating direction Y2” (FIG. 2).

The operating lever 12, in other words, is the one that can perform a tilting operation to the up-and-down direction of the vehicle centering on the neutral position, and a tilting operation to the right-and-left direction of the vehicle centering on the neutral position. Note that the up-and-down direction and the right-and-left direction are expressions of convenience indicating that the operations of upward, downward, rightward, and leftward directions of the vehicle are possible, and do not indicate the up-and-down direction and right-and-left direction of the vehicle in a strict sense.

The support mechanism 13 in this illustration is configured so that the operating lever 12 can be tilted, centering on the neutral position, to one direction and the other direction in the first operating direction Y1 only one step each. The support mechanism 13 in this illustration is further configured so that the operating lever 12 can be tilted, centering on the neutral position, to one direction and the other direction in the second operating direction Y2 only one step each. The support mechanism 13 is also provided with, in addition to the mechanism to tilt the operating lever 12, a mechanism for self-returning the operating lever 12 to the neutral position from a tilted position. Consequently, the operating lever 12 can self-return to the neutral position from the tilted position when the operating force is released, such as a case in which the operator (driver) has taken his or her hands off from the operating lever 12, after having operated by the operator.

Thus, in the main operating unit 11, when the operating lever 12 is operated to either one of the directions in the first operating direction Y1, toggling of a switch corresponding to that first operating direction Y1 is performed. Then, in the main operating unit 11, when the operating lever 12 is operated again to either one of the directions in the first operating direction Y1 after the operating lever 12 self-returns to the neutral position, further toggling of a switch corresponding to that first operating direction Y1 is performed. Furthermore, in the main operating unit 11, when the operating lever 12 is operated to either one of the directions in the second operating direction Y2, toggling of a switch corresponding to that second operating direction Y2 is performed. Then, in the main operating unit 11, when the operating lever 12 is operated again to either one of the directions in the second operating direction Y2 after the operating lever 12 self-returns to the neutral position, further toggling of a switch corresponding to that second operating direction Y2 is performed.

In this illustration, the main operating unit 11 is configured as the one that includes a self-return function to the neutral position of the operating lever 12. The main operating unit 11, however, may be configured not to include such a self-return function. In this case, it only needs to be configured so that the tilting operation of the operating lever 12, in each of the first operating direction Y1 and the second operating direction Y2, can be performed in a reciprocating direction with a plurality of steps.

The sub-operating unit 15 is a switch provided on the other end portion of the operating lever 12, and is configured as a rotary switch operable in the circumferential direction (hereinafter referred to as “third operating direction Y3”) with respect to the central axis of the other end portion of the operating lever 12. At least one sub-operating unit 15 is provided on the other end portion of the operating lever 12. The sub-operating unit 15 includes an operating member 16 that is rotatable to the third operating direction Y3.

The sub-operating unit 15 may be configured as the one that includes an annular member that covers, by making the outer diameter of the other end portion of the operating lever 12 smaller than the others, the outer circumferential surface of this smaller diameter portion, for example. In this case, the annular member serves as the operating member 16, and by the operator operating this annular member to either one of the directions in the third operating direction Y3, toggling of a switch is performed. The sub-operating unit 15 may further be configured by making a rotating shaft project from an end face of the other end portion of the operating lever 12, and by mounting the columnar, cylindrical, or shell-shaped operating member 16 on the rotating shaft, for example. In this case, the operator operates that operating member 16 to either one of the directions in the third operating direction Y3 so as to perform toggling of a switch.

The sub-operating unit 15 may be configured so that a switch is toggled in a plurality of steps by the operation of the operating member 16 to either one of the directions in the third operating direction Y3, and from this state, may be configured so that the switch is toggled in reverse in a plurality of steps by the operation of the operating member 16 to the other direction in the third operating direction Y3.

The operating member 16 may be configured so that, centering on the neutral position, it can be rotated to either one of the directions in the third operating direction Y3 only one step and can be rotated to the other direction in the third operating direction Y3 only one step. In this case, a mechanism by which the operating member 16 self-returns to the neutral position is provided between the operating member 16 and the rotating shaft. In the sub-operating unit 15, when the operating member 16 is operated to either one of the directions in the third operating direction Y3, toggling of a switch corresponding to that third operating direction Y3 is performed. Then, in the sub-operating unit 15, when the operating member 16 is operated again in either one of the directions in the third operating direction Y3 after the operating member 16 self-returns to the neutral position, further toggling of a switch corresponding to that third operating direction Y3 is performed. In this illustration, the sub-operating unit 15 is configured as the one that includes a self-return function to the neutral position of the operating member 16.

The operating device 1 in the first embodiment includes an operating direction detector that detects the operating direction of the operating unit 10 (10A, 10B). In this illustration, provided are an operating direction detector 21 for the main operating unit 11 (hereinafter referred to as “main-operating direction detector”) and an operating direction detector 22 for the sub-operating unit 15 (hereinafter referred to as “sub-operating direction detector”).

The main-operating direction detector 21 is provided being separated into a first main-operating direction detector 21A that detects an operating direction when the operating lever 12 is operated to the first operating direction Y1, and a second main-operating direction detector 21B that detects an operating direction when the operating lever 12 is operated to the second operating direction Y2. The first main-operating direction detector 21A and the second main-operating direction detector 21B are the ones that output an On signal when the operating lever 12 is tilted to the respective operating directions and that stop outputting the On signal when the operating lever 12 is returned to the neutral position. Thus, as for the first main-operating direction detector 21A and the second main-operating direction detector 21B, it only needs to use an On-Off switch that performs On-Off operation corresponding to such a movement of the operating lever 12. The first main-operating direction detector 21A and the second main-operating direction detector 21B transmit the detection signal thereof to a following controller 50. The first main-operating direction detector 21A and the second main-operating direction detector 21B are provided on the support mechanism 13, for example.

The sub-operating direction detector 22 is the one that detects an operating direction when the operating member 16 is operated to the third operating direction Y3. The sub-operating direction detector 22 is the one that outputs an On signal when the operating member 16 is rotated to the respective operating directions and that stops outputting the On signal when the operating member 16 is returned to the neutral position. Thus, as for the sub-operating direction detector 22, it only needs to use an On-Off switch that performs On-Off operation corresponding to such a movement of the operating member 16. The sub-operating direction detector 22 transmits the detection signal thereof to the controller 50. The sub-operating direction detector 22 is provided between the operating member 16 and the rotating shaft, for example.

The operating device 1 of the first embodiment includes a display unit 30 that can display an image corresponding to the operation of the operating unit 10 (10A, 10B).

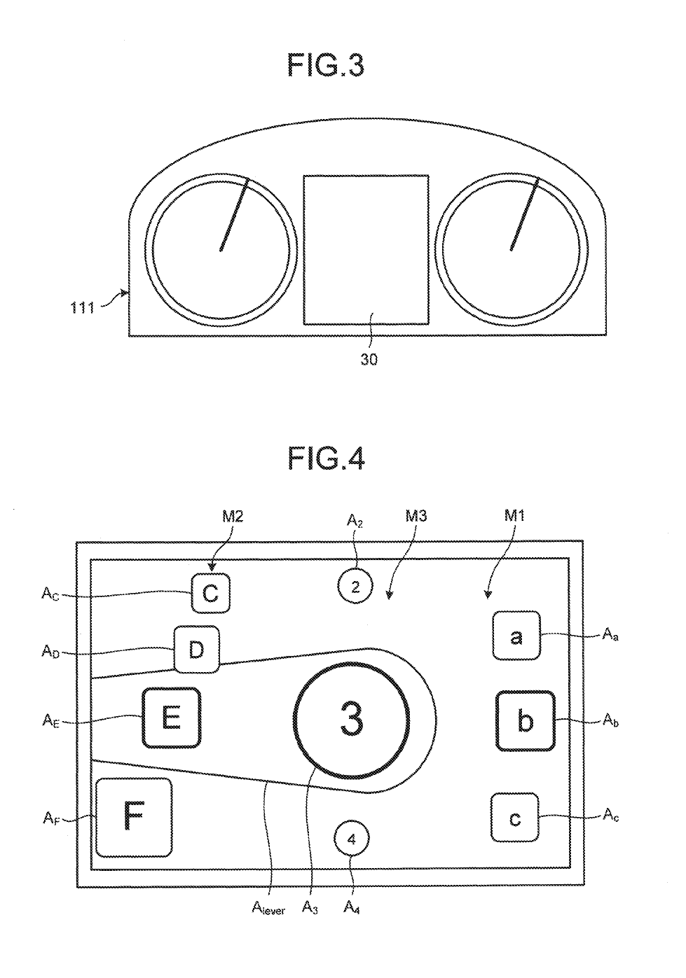

The display unit 30 is a display such as a liquid crystal display unit, for example. This display unit 30 is provided on an instrument panel (not depicted) of the vehicle interior, for example. Specifically, it is formed in a rectangle and is arranged in a combination meter 111 illustrated in FIG. 3 provided on the instrument panel. On this display unit 30, in addition to the image corresponding to the operation of the operating unit 10 (10A, 10B), a variety of information on the vehicle is displayed.

The variety of information on the vehicle is the information such as information about the current shift range of an automatic transmission (not depicted), information on fuel consumption, and information on travel distance, and is the basic information that is displayed without going through the operation of the operating device 1. On the display unit 30, when the operating unit 10 (10A, 10B) is operated, an image including selection information corresponding to the operation of the operating unit 10 (10A, 10B) is displayed in place of the basic information, if the basic information has been displayed. The selection information is the information for displaying an operation mode of the on-vehicle device selected by the operation of the operating unit 10 (10A, 10B). Thus, on the display unit 30, when the selection of another operation mode is performed by the operation of the operating unit 10 (10A, 10B) while such selection information is displayed, the selection information indicating that the other operation mode is being selected is displayed.

The operating device 1 in the first embodiment includes an operational intention detector 40 that detects the intention (hereinafter referred to as “operational intention”) of the operator to operate the operating unit 10 (10A, 10B). The switching of the display content to the selection information from the basic information is performed by utilizing a detection signal of the operational intention detector 40. The operational intention detector 40 is provided one each on the operating units 10A and 10B on the right-hand side and the left-hand side of the vehicle, respectively.

It is determined that, when a hand of the operator comes in contact with the operating unit 10 (10A, 10B) or comes close to a certain distance, the operator has an operational intention of the operating unit 10 (10A, 10B). Thus, the operational intention detector 40 is configured as to be able to detect the fact that a hand of the operator comes in contact with the operating unit 10 (10A, 10B) or comes close to a certain distance. For example, for the operational intention detector 40, a known sensor such as a piezoelectric element that can detect the contact can be utilized. In this case, when a contact has been detected, the operational intention detector 40 outputs a detection signal thereof. Furthermore, for the operational intention detector 40, a known proximity sensor such as a photoelectric sensor that can detect being close to the operating unit 10 (10A, 10B) to a certain distance can be utilized. In this case, when a hand comes close to the operating unit 10 (10A, 10B) to a certain distance, the operational intention detector 40 outputs a detection signal thereof. Such an operational intention detector 40 is arranged on the operating lever 12 or the operating member 16.

The operating device 1 in the first embodiment includes the controller 50 that controls on-vehicle devices in accordance with the operation content of the operating unit 10 (10A, 10B) and that alters the display content of the display unit 30 depending on the operation content. The controller 50 is an arithmetic processing unit (a CPU) installed in the vehicle, and is coupled to the on-vehicle devices, the first main-operating direction detector 21A, the second main-operating direction detector 21B, the sub-operating direction detector 22, the operational intention detector 40, and others.

The controller 50, when the operating lever 12 or the operating member 16 of the operating unit 10 (10A, 10B) is operated, selects a selection mode corresponding to the operating direction thereof and selects an operation mode selected by the operator in that selection mode. The controller 50 then controls an appropriate on-vehicle device so as to make it operate in the selected operation mode. That is, in the operating device 1, by a single operation of the operating lever 12 or the operating member 16, the selection of selection mode and the selection of the function (operation mode) of the on-vehicle device can be achieved at the same time. Consequently, because the operation only to select a selection mode is unnecessary, the operating device 1 improves the usability.

When the detection signal of the operational intention detector 40 is not received, the operating unit 10 (10A, 10B) is not being operated, and thus the controller 50 causes the display unit 30 to display a normal screen (not depicted) including the above-described basic information.

The controller 50, when the detection signal of the operational intention detector 40 is received while displaying the normal screen, causes the display unit 30 to display selection icons corresponding to the operation modes for each selection mode concerning the operating unit 10 (10A, 10B) for which the operational intention of the operator has been detected by the operational intention detector 40. The respective selection icons are displayed on the display unit 30 as an operation guidance screen (FIG. 4).

The operation modes of a single on-vehicle device each can be assigned to the operating unit 10A and the operating unit 10B. In this case, the selection mode of one function group of the assigned on-vehicle device is assigned to the first operating direction Y1 of the operating lever 12. The selection mode of another function group of that assigned on-vehicle device is assigned to the second operating direction Y2 of the operating lever 12. Furthermore, the selection mode of yet another function group of that assigned on-vehicle device is assigned to the third operating direction Y3 of the operating member 16. Thus, when the operational intention on either one of the operating unit 10A and the operating unit 10B has been detected, it can tell which on-vehicle device the operator desires the operation of. Consequently, when the detection signal of the operational intention detector 40 is received while displaying the normal screen, the controller 50 causes the display unit 30 to display the operation guidance screen concerning the on-vehicle device that is assigned to the operating unit 10 (10A, 10B) having that operational intention detector 40.

The operation modes of a plurality of on-vehicle devices each can be assigned to the operating unit 10A and the operating unit 10B. In this case, the first operating direction Y1 of the operating lever 12 is assigned to the selection mode of the on-vehicle device assigned to that operating direction. The second operating direction Y2 of the operating lever 12 is assigned to the selection mode of the on-vehicle device assigned to that operating direction. The third operating direction Y3 of the operating member 16 is assigned to the selection mode of the on-vehicle device assigned to that operating direction. In this case, separate on-vehicle devices may be assigned to the respective operating directions, or a first on-vehicle device may be assigned to a certain operating direction and a plurality of function groups of a second on-vehicle device may be assigned to a plurality of other directions. The controller 50, when the detection signal of the operational intention detector 40 is received while displaying the normal screen, causes the display unit 30 to display the operation guidance screen concerning a plurality of on-vehicle devices that are assigned to the operating unit 10 (10A, 10B) having that operational intention detector 40.

In FIG. 4, illustrated is an operation guidance screen that is associated with the operating unit 10A on the right-hand side of the vehicle. The operation guidance screen in FIG. 4 includes the selection icons corresponding to the operating directions of the operating lever 12 and the operating member 16 of the operating unit 10A and to the arrangements thereof with respect to the steering column 102. Note that this operation guidance screen is the one that represents one example for explanation. Thus, the number of selection icons and others is set as appropriate. The operation guidance screen that is associated with the operating unit 10B includes, the same as those of the operating unit 10A, the selection icons corresponding to the operating directions of the operating lever 12 and the operating member 16 of the operating unit 10B and to the arrangements thereof with respect to the steering column 102.

Specifically, the operation guidance screen is the one that a plurality of operation modes, out of the operation modes in the selection mode corresponding to the operating direction of the operating unit 10 (10A, 10B), are displayed on the display unit 30 as selection icons. Those selection icons are put together and displayed on the display unit 30 for each operating direction (that is, the selection mode) of the operating unit 10 (10A, 10B). In this operation guidance screen, a plurality of selection icons for each selection mode displayed on the display unit 30 are displayed in association with the operating direction of the operating unit 10 (10A, 10B) corresponding to the selection mode, such that the operator can recognize the operating direction of the operating unit 10 (10A, 10B) corresponding to the selection mode from the display content of the display unit 30. By such arrangement of the selection icons, the operator can recognize it easily to which direction the operating unit 10 (10A, 10B) needs to be operated in order to select a desired operation mode in a desired selection mode. Consequently, the operating device 1 improves the usability thereof.

The operation guidance screen in FIG. 4 includes a group of selection icons of a selection mode M1 corresponding to the first operating direction Y1, a group of selection icons of a selection mode M2 corresponding to the second operating direction Y2, and a group of selection icons of a selection mode M3 corresponding to the third operating direction Y3.

In the respective groups of selection icons on the operation guidance screen, the selection icons that are selected according to the operation of the operating unit 10 (10A, 10B) and the selection icons that are to be selected when the operating unit 10 (10A, 10B) is further operated to the same operating direction as that operation or to an opposite operating direction are included. Furthermore, there may be a case in which the respective groups of selection icons of the selection modes M1, M2, and M3 include selection icons concerning operation modes not being displayed, in addition to the ones displayed on the operation guidance screen. Thus, when the operating unit 10 (10A, 10B) is operated, the controller 50 causes the display unit 30 to display at least the selection icons that are selected according to that operation and the selection icons that become selection candidates when the operating unit 10 (10A, 10B) is further operated to the same operating direction as that operation or to an opposite operating direction.

In the group of selection icons of the selection mode M1 in FIG. 4, a selection icon Aₐ for an operation mode a of the selection mode M1, a selection icon A_{b} for an operation mode b of the selection mode M1, and a selection icon A_{c} for an operation mode c of the selection mode M1 are displayed. In order to display the selection icons Aₐ to A_{c} being visually associated with the operating direction (the first operating direction Y1) of the operating lever 12, the icons are vertically arranged side by side on the right-hand side of the vehicle on the operation guidance screen. Specifically, in accordance with the trace of the tip of the operating lever 12 (the end portion of the side on which the operating member 16 is arranged) in the operating direction (the first operating direction Y1), the selection icons Aₐ to A_{c} are vertically arranged side by side on the right-hand side of the vehicle on the operation guidance screen so as to lie along the curve of that trace. Each of the selection icons Aₐ to A_{c} is formed in a comparable size. In the selection mode M1, by the operating lever 12 being operated to either one of the directions in the first operating direction Y1, any one of the selection icons Aₐ to A_{c} is selected.

While three selection icons Aₐ to A_{c} are displayed here, on the operation guidance screen, two or more selection icons in the selection mode M1 only need to be displayed. When the selection mode M1 has four or more operation modes, those three selection icons Aₐ to A_{c} may be displayed on the operation guidance screen and, when the operating lever 12 is operated to the first operating direction Y1, the one on the end portion of the operating direction side out of those three icons may be erased from the operation guidance screen and the one out of the remaining operation modes in a non-display state (that is, the operation mode that may be selected subsequent to the next one) may be displayed on the end portion of the opposite side to the operating direction on the operation guidance screen, for example. Consequently, in the display unit 30, there is no need to display all the selection icons in the selection mode M1, and thus the selection icons on the operation guidance screen can be displayed larger. In this illustration, selection icons Aₐ to A_{f} that are associated with operation modes a to f, respectively, are prepared as the group of selection icons of the selection mode M1.

In the group of selection icons of the selection mode M2 in FIG. 4, a selection icon A_{C} for an operation mode C of the selection mode M2, a selection icon A_{D} for an operation mode D of the selection mode M2, a selection icon A_{E} for an operation mode E of the selection mode M2, and a selection icon A_{F} for an operation mode F of the selection mode M2 are displayed. In order to display the selection icons A_{A} to A_{F} being visually associated with the operating direction (the second operating direction Y2) of the operating lever 12, the icons are vertically arranged side by side on the left-hand side of the vehicle on the operation guidance screen. Specifically, the selection icons A_{C} to A_{F} are arranged side by side diagonally with respect to the longitudinal direction on the left-hand side of the vehicle on the operation guidance screen such that the trace of the operating lever 12 in the operating direction (the second operating direction Y2) is visually represented. The selection icons A_{C} to A_{F} are gradually shifted to the right-hand side of the vehicle toward the top on the operation guidance screen. The size of the selection icons A_{C} to A_{F} is made gradually smaller toward the top on the operation guidance screen. In the selection mode M2, by the operating lever 12 being operated to either one of the directions in the second operating direction Y2, any one of the selection icons A_{C} to A_{F} is selected.

While four selection icons A_{C} to A_{F} are displayed here, on the operation guidance screen, two or more selection icons in the selection mode M2 only need to be displayed. When the selection mode M2 has five or more operation modes, those four selection icons A_{C} to A_{F} may be displayed on the operation guidance screen and, when the operating lever 12 is operated to the second operating direction Y2, the one on the end portion of the operating direction side out of those four icons may be erased from the operation guidance screen and the one out of the remaining operation modes in a non-display state (that is, the operation mode that may be selected later) may be displayed on the end portion of the opposite side to the operating direction on the operation guidance screen, for example. Consequently, in the display unit 30, there is no need to display all the selection icons in the selection mode M2, and thus the selection icons on the operation guidance screen can be displayed larger. In this illustration, selection icons A_{A} to A_{F} that are associated with operation modes A to F, respectively, are prepared as the group of selection icons of the selection mode M2.

In the group of selection icons of the selection mode M3 in FIG. 4, a selection icon A₂ for an operation mode 2 of the selection mode M3, a selection icon A₃ for an operation mode 3 of the selection mode M3, and a selection icon A₄ for an operation mode 4 of the selection mode M3 are displayed. In order to display the selection icons A₂ to A₄ being visually associated with the operating direction (the third operating direction Y3) of the operating member 16, the icons are vertically arranged side by side in the middle of the operation guidance screen. Specifically, in order for the trace of the rotation of the operating member 16 in the operating direction (the third operating direction Y3) to be visually represented, the selection icons A₂ to A₄ are vertically arranged side by side in the middle of the operation guidance screen and the respective selection icons A₂ to A₄ are formed such that the selection icon A₃ arranged at the center is the largest and such that the selection icons A₂ and A₄ arranged above and below are smaller than the selection icon A₃ at the center. In the selection mode M3, by the operating member 16 being operated to either one of the directions in the third operating direction Y3, any one of the selection icons A₂ to A₄ is selected.

While three selection icons A₂ to A₄ are displayed here, on the operation guidance screen, two or more selection icons in the selection mode M3 only need to be displayed. When the selection mode M3 has four or more operation modes, those three selection icons A₂ to A₄ may be displayed on the operation guidance screen and, when the operating member 16 is operated to the third operating direction Y3, the one on the end portion of the operating direction side out of those three icons may be erased from the operation guidance screen and the one out of the remaining operation modes in a non-display state (that is, the operation mode that may be selected subsequent to the next one) may be displayed on the end portion of the opposite side to the operating direction on the operation guidance screen, for example. Consequently, in the display unit 30, there is no need to display all the selection icons in the selection mode M3, and thus the selection icons on the operation guidance screen can be displayed larger. In this illustration, selection icons A₁ to A₄ that are associated with operation modes 1 to 4, respectively, are prepared as the group of selection icons of the selection mode M3.

The controller 50 moves moving targets out of the selection icons Aₐ to A_{f} in the selection mode corresponding to the operating direction on the display unit 30, each time the operating unit 10 (10A, 10B) is operated. For example, in the selection mode M1, when the operating lever 12 is operated downward in the first operating direction Y1 (the up-and-down direction), the selection icons are moved downward one by one while the number of icons in display remains as is. Consequently, on the operation guidance screen, the selection icon that has been displayed on the lowermost side is deleted and a selection icon that has not been displayed appears on the uppermost side. In this point, it is the same when the operating lever 12 is operated upward in the first operating direction Y1 (the up-and-down direction), and it is also the same in the selection mode M2 and the selection mode M3.

Furthermore, the controller 50 makes the display of the selection icon visually prominent in the selection mode selected according to the operation of the operating unit 10 (10A, 10B). The display is made visually prominent by highlighting the appropriate selection icon, for example. The controller 50 makes the selection icon moved to a certain highlight position visually prominent out of the selection icons displayed on the display unit 30. For example, the selection icon selected according to the operation of the operating unit 10 (10A, 10B) is arranged in the middle portion of the up-and-down direction on the operation guidance screen. In this illustration, the middle portion is defined as the certain highlight position. When a stop state of the on-vehicle devices also is displayed as the selection icon, by regarding the selection of the stop state also as the operational intention of the operator, as illustrated in FIG. 4, all of the selection icons A_{b}, A_{E}, and A₃ at the middle portions may be made visually prominent. By making the selection icons visually prominent in this way, the operator can comprehend at a glance the operation modes that the operator himself/herself has selected. Thus, the operating device 1 improves the usability thereof.

The operation guidance screen further includes an operating unit icon Aₗₑᵥₑᵣ that represents the appearance of the operating unit 10A. The operating unit icon Aₗₑᵥₑᵣ is an image that collectively displays the tip side of the operating lever 12 together with the operating member 16. On the operation guidance screen, the groups of selection icons of the respective selection modes M1, M2, and M3 are displayed near the operating unit icon Aₗₑᵥₑᵣ. In this illustration, the group of selection icons of the selection mode M1 is arranged on the right-hand side of the vehicle relative to the operating unit icon Aₗₑᵥₑᵣ, and the groups of selection icons of the selection modes M2 and M3 are arranged in front of the operating unit icon Aₗₑᵥₑᵣ. Consequently, the operator can comprehend at a glance the correspondence relation between the respective selection icons on the operation guidance screen, and the operating directions of the operating lever 12 and the operating member 16. Thus, the operating device 1 improves the usability thereof. On the operation guidance screen, an operating unit icon for the operating lever 12 and an operating unit icon for the operating member 16 may be displayed separately. Furthermore, on the operation guidance screen, an operating unit icon may be displayed separately for each of the selection modes M1, M2, and M3.

As in the foregoing, the operation modes of a single on-vehicle device each can be assigned to the operating unit 10A and the operating unit 10B. For example, when an air conditioning unit is assigned to the operating unit 10A, on the operation guidance screen, selection icons for switching between a manual mode and an automatic mode are arranged for the selection mode M1, selection icons for switching outlets are arranged for the selection mode M2, and selection icons for adjusting air flow are arranged for the selection mode M3.

Furthermore, as in the foregoing, the operation modes of a plurality of on-vehicle devices each can be assigned to the operating unit 10A and the operating unit 10B. For example, when front windshield wipers and a rear windshield wiper are assigned to the operating unit 10A, on the operation guidance screen, selection icons for switching the operation and speed of the front windshield wipers are arranged for the selection mode M1, selection icons for performing spraying of washer fluid and operating the front windshield wipers are arranged for the selection mode M2, and selection icons for switching the operation and speed of the rear windshield wiper are arranged for the selection mode M3.

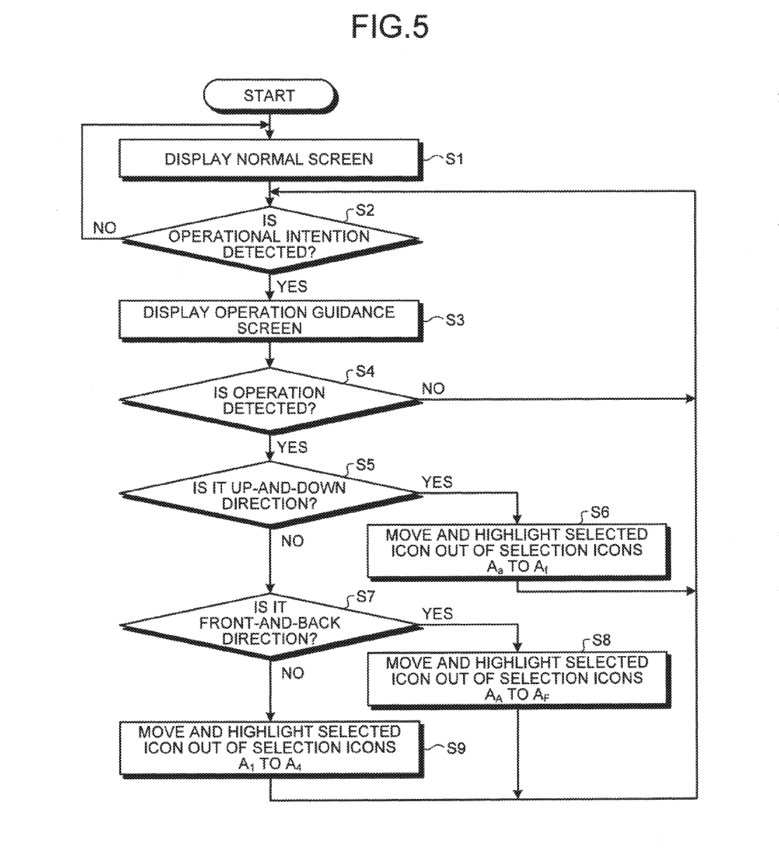

In the following description, one example of arithmetic process operation performed in the operating device 1 will be described based on the flowchart in FIG. 5.

The controller 50 starts the arithmetic process operation upon detecting an On signal of an ignition switch. First, the controller 50, immediately after receiving the On signal of the ignition switch, causes the display unit 30 to display a normal screen including the above-described basic information (Step S1).

When an operational intention of the operator for the operating unit 10 (10A, 10B) is not detected in a state of displaying the normal screen, that is, when the detection signal of the operational intention detector 40 is not received (No at Step S2), the controller 50 returns to Step S1 and continues the display of the normal screen.

Meanwhile, when the operational intention of the operator for the operating unit 10 (10A, 10B) has been detected, that is, when the detection signal of the operational intention detector 40 is received (Yes at Step S2), the controller 50 causes the display unit 30 to display, in place of the normal screen, the operation guidance screen corresponding to the operating unit 10 (the operating unit 10A or the operating unit 10B) that includes that operational intention detector 40 (Step S3). Thus, the operator understands what kind of operation mode can be selected by how the operating unit 10 (10A, 10B) is operated. Consequently, the operating device 1 improves the usability thereof.

When a detection signal from any of the first main-operating direction detector 21A, the second main-operating direction detector 21B, and the sub-operating direction detector 22 of the operating unit 10 (10A, 10B) is not received, that is, when the operation of the operating unit 10 (10A, 10B) by the operator is not detected (No at Step S4), the controller 50 returns to Step S2. When the operational intention is being detected at this Step S2, the controller 50 advances to Step S3. Meanwhile, when the operational intention is no longer detected at Step S2, the controller 50 returns to Step S1 and switches the display content of the display unit 30 to the normal screen from the operation guidance screen.

When a detection signal from any one of the first main-operating direction detector 21A, the second main-operating direction detector 21B, and the sub-operating direction detector 22 is received, that is, when the operation of the operating unit 10 (10A, 10B) by the operator has been detected (Yes at Step S4), the controller 50 determines whether the operating direction is the up-and-down direction (the first operating direction Y1) (Step S5).

When the operating direction is the up-and-down direction (the first operating direction Y1), the controller 50 moves the selection icon, which has been selected by that operation out of the selection icons Aₐ to A_{f} of the selection mode M1, to the middle portion of the operation guidance screen and makes it visually prominent (Step S6). For example, when the operating lever 12 is operated downward in the up-and-down direction (the first operating direction Y1), the controller 50 brings down the displayed selection icons of the selection mode M1 downward one by one, deletes the selection icon of the lowermost side displayed in the selection mode M1, and makes a new selection icon appear on the uppermost side of the selection mode M1. The controller 50 then makes the selection icon moved to the middle portion of the operation guidance screen visually prominent. Thereafter, if the further operation to the operating unit 10 (10A, 10B) is not performed within a certain time period, the controller 50 performs control so that the on-vehicle device is to be in the operation mode concerning the selection icon made visually prominent.

When the operating direction is not the up-and-down direction (the first operating direction Y1), the controller 50 determines whether the operating direction is the front-and-back direction (the second operating direction Y2) (Step S7).

When the operating direction is the front-and-back direction (the second operating direction Y2), the controller 50 moves the selection icon, which has been selected by that operation out of the selection icons A_{A} to A_{F} of the selection mode M2, to the middle portion of the operation guidance screen and makes it visually prominent (Step S8). The detail of that is the same as those described at Step S6, and thus the explanation here is omitted.

When the operating direction is not the front-and-back direction (the second operating direction Y2), the operating direction is the rotational direction (the third operating direction Y3), and thus the controller 50 moves the selection icon, which has been selected by that operation out of the selection icons A₁ to A₄ of the selection mode M3, to the middle portion of the operation guidance screen and makes it visually prominent (Step S9). The detail of that is the same as those described at Step S6, and thus the explanation here is omitted.

As in the foregoing, the operating device 1 in the first embodiment uniquely associates the operating directions of the operating lever 12 and the operating member 16 with the selection modes. Then, the operating device 1 causes the display unit 30 to display a plurality of operation modes for each selection mode as the selection icons out of the operation modes in the selection mode corresponding to the operating direction. Thus, the operating device 1 can let the operator know what kind operation mode of what kind of selection mode can be selected by how the operating unit 10 (10A, 10B) is operated. Consequently, in the operating device 1, because the display content thereof can be referred to, the selection of the selection mode and the selection of the function (the operation mode) of the on-vehicle device can be performed at the same time, without performing a special operation for selecting the selection mode, by only performing a single operation of the operating lever 12 or the operating member 16 while referring to the display content. Furthermore, in the operating device 1, by referring to the display content, the moving of the line of vision to the operating lever 12 and the operating member 16 can be suppressed. As in the foregoing, the operating device 1 has improved the usability. Consequently, in the operating device 1, a desired on-vehicle device can be operated easily and with no errors. Moreover, in the operating device 1, even when a plurality of on-vehicle devices are operation targets, the respective on-vehicle devices can be operated easily and with no errors.

Meanwhile, in the operating device 1 in the first embodiment, the operational intention detector 40 is provided, and thus, when the detection signal is received, the display unit 30 is switched to the operation guidance screen from the normal screen. The operational intention detector 40, however, does not necessarily need to be provided on the operating device 1. In this case, it only needs to provide the display unit 30 as the one that exclusively displays the operation guidance screen and to make the display unit 30 display the operation guidance screen from the beginning.

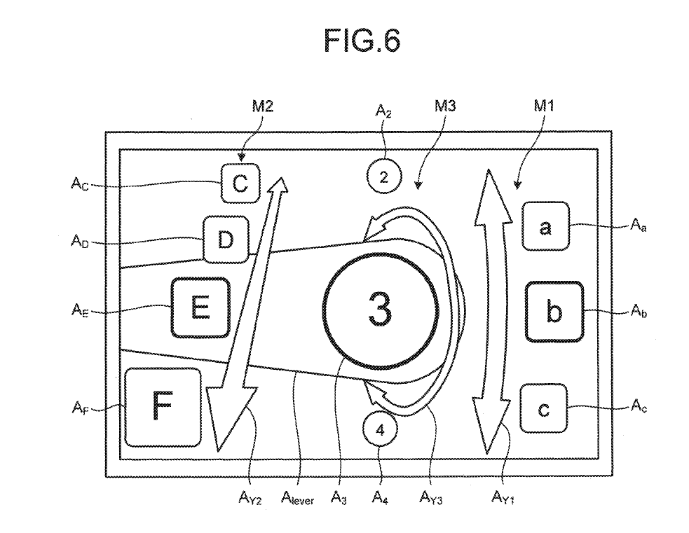

Furthermore, on the operation guidance screen, as illustrated in FIG. 6, operating direction icons A_{Y1}, A_{Y2}, and A_{Y3} may be provided. Those operating direction icons A_{Y1}, A_{Y2}, and A_{Y3} are the ones that indicate the operating directions of the operating lever 12 and the operating member 16 of the operating unit 10 (10A, 10B). The controller 50 causes the display unit 30 to display, for each selection mode, those operating direction icons A_{Y1}, A_{Y2}, and A_{Y3} side by side with a plurality of selection icons of that selection mode. The operating direction icon A_{Y1} is the one that indicates the first operating direction Y1, and is composed of an arrow in a reciprocating direction along the array of the selection icons Aₐ to A_{f} of the selection mode M1. This operating direction icon A_{Y1} is arranged side by side near the selection icons Aₐ to A_{f}. The operating direction icon A_{Y2} is the one that indicates the second operating direction Y2, and is composed of an arrow in a reciprocating direction along the array of the selection icons A_{A} to A_{F} of the selection mode M2. This operating direction icon A_{Y2} is arranged side by side near the selection icons A_{A} to A_{F}. The operating direction icon A_{Y3} is the one that indicates the third operating direction Y3, and is composed of an arrow in a reciprocating direction that represents the rotational direction. This operating direction icon A_{Y3} is arranged side by side near the selection icons A₁ to A₄ of the selection mode M3. By providing the operating direction icons A_{Y1}, A_{Y2}, and A_{Y3} on the operation guidance screen this way, as compared with the operation guidance screen in FIG. 4, the operator can further easily recognize a direction in which the operating unit 10 (10A, 10B) needs to be operated in order to select a desired operation mode in a desired selection mode. Consequently, the operating device 1 improves the usability thereof. The operating direction icons A_{Y1}, A_{Y2}, and A_{Y3} do not necessarily need to be arrows and, because the operator only needs to understand the operating directions of the operating unit 10 (10A, 10B), characters and others may be used.

The operating unit 10 only needs to be the one that a plurality of operations can be performed thereon, and thus it may be a cross key and others provided on the steering wheel 101, for example.

### Second Embodiment

The foregoing operating device 1 in the first embodiment includes one operating unit 10 (10A, 10B) each on the right and left of the vehicle with respect to the steering column 102. Meanwhile, there may be a case that a plurality of operating units 10 are provided on at least one of the right-hand side of the vehicle and the left-hand side of the vehicle. Then, when a plurality of operating units 10 are provided on one side, the operator may, by visually observing the characters and marks concerning the operation modes that are printed on the operating unit 10, for example, check which operating unit 10 the operator is operating or trying to operate. However, because that operating unit 10 is arranged on the rear side of the steering wheel 101, the operator may be unable to visually observe the characters and others of the operating unit 10 unless the operator looks in, and the operator may feel it bothersome. Furthermore, in the operating device 1 in the first embodiment, by making the display unit 30 display the operation guidance screen, without visually observing the operating unit 10 directly, the operator can comprehend which operating unit 10 the operator is operating or trying to operate. However, that operation guidance screen instantaneously appears in the middle portion of the display unit 30 irrespective of the arrangement of the operating unit 10. Thus, unless observing that operation guidance screen closely, the operator is hard to comprehend which operating unit 10 the operator is operating or trying to operate, and thus the operator may feel it bothersome.

In a second embodiment, the operating device is configured such that the operator does not feel such a bother.

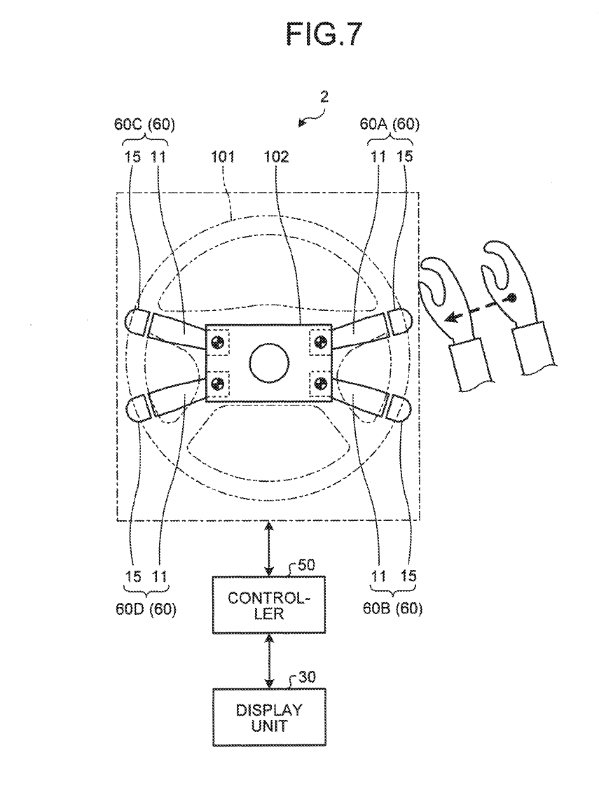

The reference sign 2 in FIG. 7 represents the operating device in the second embodiment. This operating device 2 is, with respect to the operating device 1 in the first embodiment, the one that the operating unit 10 is replaced with an operating unit 60 and the display function of the controller 50 to the display unit 30 is modified.

In the operating device 2, four operating units 60A, 60B, 60C, and 60D are provided as the operating unit 60. In this illustration, with respect to the steering column 102, the operating units 60A and 60B are arranged on the right-hand side of the vehicle and the operating units 60C and 60D are arranged on the left-hand side of the vehicle. The operating unit 60 in the second embodiment includes, like the operating unit 10 in the first embodiment, the main operating unit 11 that includes the operating lever 12 and the support mechanism 13, the sub-operating unit 15 that includes the operating member 16, the first main-operating direction detector 21A, the second main-operating direction detector 21B, the sub-operating direction detector 22, and the operational intention detector 40.

The operating lever 12 of the operating unit 60A projects toward the right of the vehicle and upward from the side surface of the steering column 102 on the right-hand side of the vehicle. The operating lever 12 of the operating unit 60B projects toward the right of the vehicle and downward from the side surface of the steering column 102 on the right-hand side of the vehicle. Meanwhile, the operating lever 12 of the operating unit 60C projects toward the left of the vehicle and upward from the side surface of the steering column 102 on the left-hand side of the vehicle. The operating lever 12 of the operating unit 60D projects toward the left of the vehicle and downward from the side surface of the steering column 102 on the left-hand side of the vehicle.

The operation modes of windshield wipers are assigned to the operating unit 60A. The operation modes of acoustic equipment are assigned to the operating unit 60B. The operation modes of turn signals are assigned to the operating unit 60C. The operation modes of an air conditioning unit are assigned to the operating unit 60D. These assignments are one example for the following explanation.

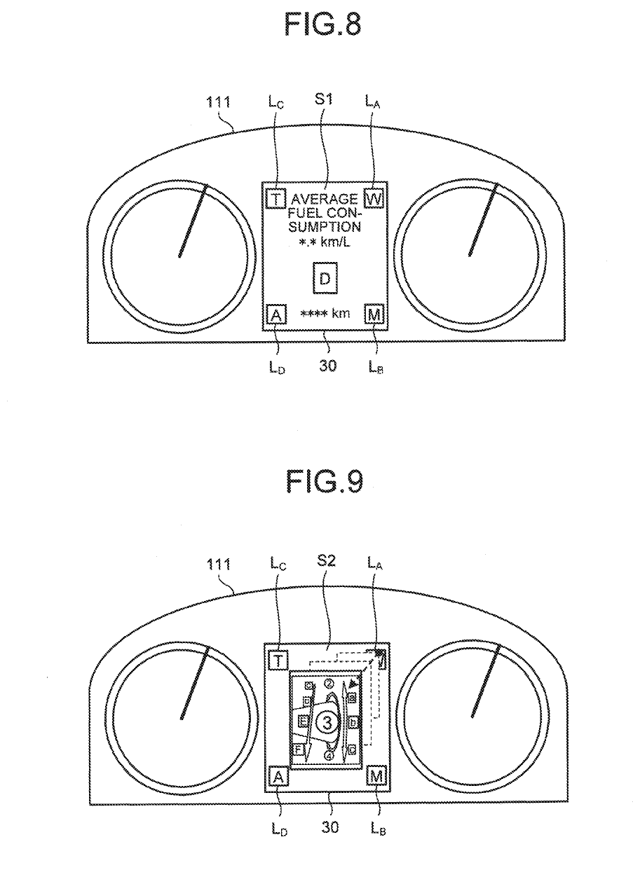

In this illustration, the circumferential edge portions of the display unit 30 on the right-hand side of the vehicle and on the left-hand side of the vehicle are, with respect to the steering column 102, associated with the right-hand side of the vehicle and the left-hand side of the vehicle, respectively. Then, as illustrated in FIG. 8, the controller 50 displays, on the circumferential edge portions of the display unit 30 on the right-hand side of the vehicle and on the left-hand side of the vehicle, operating-unit position icons L_{A}, L_{B}, L_{C}, and L_{D} that indicate the arrangement of the respective operating units 60A, 60B, 60C, and 60D with respect to the steering column 102. In this illustration, the operating-unit position icons L_{A}, L_{B}, L_{C}, and L_{D} are displayed at the four corners of the display unit 30. The operating-unit position icons L_{A}, L_{B}, L_{C}, and L_{D} are displayed together with a normal screen S1 that is the same as the one explained in the first embodiment.

Those operating-unit position icons L_{A}, L_{B}, L_{C}, and L_{D} are the ones for getting the arrangement of the operating units 60A, 60B, 60C, and 60D with respect to the steering column 102 visually recognized on the display unit 30. On these operating-unit position icons L_{A}, L_{B}, L_{C}, and L_{D}, the characters and marks that indicate what are the on-vehicle devices associated with the respective operating units 60A, 60B, 60C, and 60D may be provided.

The operating-unit position icon L_{A} is arranged at the upper right corner of the display unit 30, and has a character “W” representing the windshield wipers that are assigned to the operating unit 60A. The operating-unit position icon L_{B} is arranged at the lower right corner of the display unit 30, and has the first letter “M” of media associated with the acoustic equipment that is assigned to the operating unit 60B. The operating-unit position icon L_{C} is arranged at the upper left corner of the display unit 30, and has a character “T” representing the turn signals that are assigned to the operating unit 60C. The operating-unit position icon L_{D} is arranged at the lower left corner of the display unit 30, and has a character “A” representing the air conditioner that is assigned to the operating unit 60D.

The controller 50, as in the first embodiment, when the operational intention of the operator has been detected by the operational intention detector 40, can grasp the operating unit 60 (60A, 60B, 60C, 60D) that includes that operational intention detector 40. In the first embodiment, by making the operation guidance screen concerning that grasped operating unit 60 (60A, 60B, 60C, 60D) instantaneously appear on the display unit 30 in place of the normal screen, the selection icons concerning the operating unit 60 (60A, 60B, 60C, 60D) for each selection mode are displayed. Meanwhile, the controller 50 in the second embodiment makes an operation guidance screen S2 concerning that grasped operating unit 60 (60A, 60B, 60C, 60D) appear from the position of the circumferential edge portion of the display unit 30 associated with the operating unit 60 (60A, 60B, 60C, 60D) (that is, the position of the operating-unit position icon L_{A}, L_{B}, L_{C}, or L_{D}) while erasing the display content on display (the normal screen S1), for example. Thus, the controller 50 makes the selection icons concerning that operating unit 60 (60A, 60B, 60C, 60D) for each selection mode appear from the position of the operating-unit position icon L_{A}, L_{B}. L_{C}, or L_{D} associated with the operating unit 60 (60A, 60B, 60C, 60D).

FIG. 9 is the one that represents one example of the appearance form of the operation guidance screen S2. In this case, because the detection signal of the operational intention detector 40 in the operating unit 60A has been detected, the controller 50 performs on the display unit 30 the display control of the operation guidance screen S2 that concerns the operating unit 60A. The controller 50 in this illustration gradually expands the display of that operation guidance screen S2 toward the middle portion of the display unit 30 from the size of the operating-unit position icon L_{A}, with the position of the operating-unit position icon L_{A} associated with the operating unit 60A as the origin. The arrow in FIG. 9 is the one that indicates the direction of moving the operation guidance screen S2 at the time of that display expansion for explanation, and there is no need to display it on the display unit 30. However, it may be displayed on the display unit 30 as one of visual effects. In FIG. 9, for the convenience of explanation, the operation guidance screen in FIG. 6 is displayed as one example.

The controller 50 may make the operation guidance screen S2 in the size of a final form after display expansion appear at the position of the operating-unit position icon L_{A} of the display unit 30, and may move this operation guidance screen S2 to the middle portion of the display unit 30 from this position. The operation guidance screen S2 at the time of appearance may be made to appear so that the whole thereof is displayed on the display unit 30, and only the tip portion thereof (the lower left corner in this illustration) in the direction of moving toward the middle portion of the display unit 30 may be made to appear.

Moreover, to obtain the visual effect, the controller 50 may move the operation guidance screen S2 while gradually increasing the brightness thereof, for example. The controller 50, to obtain the visual effect, not only moving the operation guidance screen S2 simply, may move the operation guidance screen S2 while rotating it by animations, for example. Thus, it impresses on the operator the correspondence relation of the position of the operating unit 60 and the operation mode of the on-vehicle device that is assigned to that operating unit 60. Consequently, the operating device 2 can expedite the mastering of the operation.

As in the foregoing, because the operating device 2 in the second embodiment makes the operation guidance screen S2 appear from the position on the display unit 30 corresponding to the arrangement of the operating unit 60 to which the operator indicated the operational intention, it can make the operator promptly comprehend which operating unit 60 the operator is operating or trying to operate, and also make the operator promptly comprehend that that operating unit 60 is the one to operate what kind of operation mode of which on-vehicle device. Consequently, the operating device 2 improves the usability thereof.

When a plurality of operating units 60 are provided at least on one side out of the right-hand side of the vehicle and the left-hand side of the vehicle, the operator may touch an operating unit 60 that is not intended at the time of operating an operating unit 60 out of the adjacent operating units 60 without visually observing it. However, in the operating device 2, because the operation guidance screen S2 appears at the time of touching such an unintended operating unit 60 or immediately before touching it, the position of that operating unit 60 can be comprehended from the position at which the operation guidance screen S2 has appeared. Because of this, the operator can easily comprehend, before performing an erroneous operation to that operating unit 60, the position of the operating unit 60 that the operator originally desired to select, and thus the operator can quickly perform the switching to the correct operating unit 60. Consequently, in the operating device 2, even when a plurality of operating units 60 are adjacent on the right-hand side of the vehicle and on the left-hand side of the vehicle, the operator can easily comprehend the operation mode of the on-vehicle device assigned to the operating unit 60, without moving the line of vision to the operating unit 60 at hand, by the display content of the display unit 30 of less moving of line of vision than that. Thus, the operating device 2 improves the usability thereof and makes an easy-to-use operation possible.

The operating device according to the present invention uniquely associates the operating direction of the operating unit with the selection modes. Then, the operating device causes the display unit to display a plurality of operation modes for each selection mode as the selection icons out of the operation modes in the selection mode corresponding to the operating direction. Thus, the operating device can let the operator know what kind of operation mode of what kind of selection mode can be selected by how the operating unit is operated. Consequently, in the operating device, because the display content thereof can be referred to, the selection of the selection mode and the selection of the function (operation mode) of the on-vehicle device can be performed at the same time, without performing a special operation for selecting the selection mode, by only operating the operating unit while referring to the display content. Thus, the operating device improves the usability. Consequently, in the operating device, a desired on-vehicle device can be operated easily and with no errors. Moreover, in the operating device, even when a plurality of on-vehicle devices are operation targets, the respective on-vehicle devices can be operated easily and with no errors.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An operating device comprising:
an operating unit configured to select by an operator a plurality of operation modes of an on-vehicle device as an operation target, operable in an operating direction assigned for each of a plurality of selection modes, and capable of selecting the respective operation modes of the selection mode assigned to the operating direction according to an operation to the operating direction;
an operating direction detector that detects an operating direction of the operating unit;
a display unit that displays an image corresponding to an operation of the operating unit; and
a controller configured to control the on-vehicle device depending on operation content of the operating unit and alter display content of the display unit depending on the operation content, wherein
the controller causes the display unit to display as selection icons a plurality of operation modes out of the respective operation modes in the selection mode corresponding to an operating direction of the operating unit and to make the selection icon of the selection mode selected according to the operation of the operating unit visually prominent.

2. The operating device according to claim 1, wherein
the controller displays a plurality of selection icons for each selection mode displayed on the display unit in association with operating directions of the operating unit corresponding to the selection mode so as to enable the operator to recognize the operating directions of the operating unit corresponding to the selection mode from the display content of the display unit.

3. The operating device according to claim 2, wherein
the controller causes the display unit to display for each selection mode an operating direction icon indicative of an operating direction of the operating unit side by side with a plurality of selection icons in the selection mode.

4. The operating device according to claim 1, wherein
the controller causes the display unit to display an operating unit icon that represents appearance of the operating unit.

5. The operating device according to claim 2, wherein
the controller causes the display unit to display an operating unit icon that represents appearance of the operating unit.

6. The operating device according to claim 3, wherein
the controller causes the display unit to display an operating unit icon that represents appearance of the operating unit.

7. The operating device according to claim 1, wherein
the controller moves the respective selection icons in the selection mode corresponding to the operating direction on the display unit each time the operating unit is operated, and out of the respective selection modes displayed on the display unit, makes the selection icon moved to a certain highlight position visually prominent.

8. The operating device according to claim 2, wherein
the controller moves the respective selection icons in the selection mode corresponding to the operating direction on the display unit each time the operating unit is operated, and out of the respective selection modes displayed on the display unit, makes the selection icon moved to a certain highlight position visually prominent.

9. The operating device according to claim 3, wherein
the controller moves the respective selection icons in the selection mode corresponding to the operating direction on the display unit each time the operating unit is operated, and out of the respective selection modes displayed on the display unit, makes the selection icon moved to a certain highlight position visually prominent.

10. The operating device according to claim 4, wherein
the controller moves the respective selection icons in the selection mode corresponding to the operating direction on the display unit each time the operating unit is operated, and out of the respective selection modes displayed on the display unit, makes the selection icon moved to a certain highlight position visually prominent.

11. The operating device according to claim 1, wherein
the controller, when the operating unit is operated, causes the display unit to display at least the selection icon selected according to the operation of the operating unit and the selection icon that is to be selected when the operating unit is further operated to the operating direction the same as or opposite to the operation.

12. The operating device according to claim 2, wherein
the controller, when the operating unit is operated, causes the display unit to display at least the selection icon selected according to the operation of the operating unit and the selection icon that is to be selected when the operating unit is further operated to the operating direction the same as or opposite to the operation.

13. The operating device according to claim 3, wherein
the controller, when the operating unit is operated, causes the display unit to display at least the selection icon selected according to the operation of the operating unit and the selection icon that is to be selected when the operating unit is further operated to the operating direction the same as or opposite to the operation.

14. The operating device according to claim 4, wherein
the controller, when the operating unit is operated, causes the display unit to display at least the selection icon selected according to the operation of the operating unit and the selection icon that is to be selected when the operating unit is further operated to the operating direction the same as or opposite to the operation.

15. The operating device according to claim 7, wherein
the controller, when the operating unit is operated, causes the display unit to display at least the selection icon selected according to the operation of the operating unit and the selection icon that is to be selected when the operating unit is further operated to the operating direction the same as or opposite to the operation.

16. The operating device according to claim 1, further comprising:
an operational intention detector that detects an operational intention of the operating unit by the operator, wherein
the controller causes the display unit to display the selection icons when an operational intention of the operator for the operating unit has been detected by the operational intention detector.

17. The operating device according to claim 16, wherein
a plurality of operating units are provided and the operational intention detector is provided for each of the operating units, and
the controller causes the display unit to display the selection icons for each selection mode concerning the operating unit for which the operational intention of the operator has been detected by the operational intention detector.

18. The operating device according to claim 17, wherein
the respective operating units are arranged on a right-hand side of a vehicle and/or a left-hand side of the vehicle with respect to a steering column in vehicle interior,
the controller associates circumferential edge portions of the display unit on the right-hand side of the vehicle and the left-hand side of the vehicle with the right-hand side of the vehicle and the left-hand side of the vehicle with respect to the steering column, respectively, and displays operating-unit position icons indicative of arrangement of the respective operating units with respect to the steering column on the circumferential edge portions of the display unit on the right-hand side of the vehicle and the left-hand side of the vehicle, and
the controller grasps the operating unit for which an operational intention of the operator is detected by the operational intention detector, and makes the selection icons for each selection mode concerning the grasped operating unit appear from a position of the circumferential edge portion of the display unit associated with the operating unit.

19. The operating device according to claim 1, wherein
the operating unit includes a lever switch that includes an operating lever projecting from a steering column in vehicle interior, and
the operating lever is configured to be operable in a plurality of directions with respect to a neutral position.

20. The operating device according to claim 19, wherein
the operating unit includes a rotary switch that is a switch provided at an end portion on an opposite side of a fulcrum point of the operating lever and is operable in a circumferential direction with respect to a central axis of the operating lever.
